(19) United States
(12) Patent Application Publication
(10) Pub. No.: US 2024/0337484 A1
(43) Pub. Date: Oct. 10, 2024

(54) METHOD FOR DETERMINING LOCATIONAL POINTS ON AN ENAMELLED SURFACE, IN PARTICULAR AN ENAMELLED INNER WALL OF A VESSEL

(71) Applicant: THALETEC GmbH, Thale (DE)

(72) Inventor: Jurgen Reinemuth, Blankenburg (DE)

(73) Assignee: THALETEC GmbH, Thale (DE)

(21) Appl. No.: 18/709,868

(22) PCT Filed: Nov. 17, 2022
(86) PCT No.: PCT/EP2022/082296

§ 371 Date: May 14, 2024

(30) Foreign Application Priority Data
Nov. 19, 2021 (DE) 10 2021 130 292.7

(51) Int. Cl. G01B 21/04

(52) U.S. Cl. CPC G01B 21/047

(57) ABSTRACT

The present invention relates to a method for reproducibly locating one or more locational points on an enamelled surface of an apparatus, in particular an enamelled inner wall of a process-engineering vessel, wherein at least one reference point is provided on the enamelled surface, and the at least one reference point is a trough-like depression (3) in the enamelled surface, wherein the point to be located is the at least one trough-like depression (3) itself or can be determined with the aid of the at least one trough-like depression (3), and also a process-engineering vessel with an enamelled inner wall or a built-in part for a process-engineering vessel which is at least partially enamelled, wherein the enamelling is provided with at least one trough-like depression (3) for reproducibly locating locational points.

The present invention relates to a method for reproducibly locating locational points on an enameled surface, in particular on an enameled inner wall of process-engineering vessels, in an easy way as well as a vessel or enameled component that is set up for the method according to the invention.

Locational points in terms of the invention are, in particular, points at which measurements are performed, in particular measurements that are repeated at intervals in time and are to be performed at exactly the same position in order to allow secure statements to be made about changes in state.

Enamel coatings of surfaces are often provided for vessels and vessel components for process-engineering applications in chemistry and pharmacology, for example, in which aggressive media are employed or arise during processing, in order to protect the surfaces that are in contact with the product.

These enamel coatings are very durable and can offer a diverse range of uses. In particular, they are very resistant towards acids and are extremely resistant to corrosion.

A prerequisite for ensuring surface protection, however, is that the enamel coatings are free of defects, are in themselves closed, and are adequately thick and completely cover the underlying steel surface, in particular in the regions that come into contact with the medium. During operation, defects can arise, including a reduction in the thickness of the enamel coating on account of wear, in particular on the inner walls of the vessels that are in contact with the product. Therefore, process-engineering enameled vessels have to be inspected and checked. In the course of such inspections, among other things, the integrity of the enamel coating in the interior of a vessel is examined. This examination comprises a visual control of the enamel coating: a check for pores, and a check of the coating layer thickness.

For an examination, it is desirable that each point of the surface to be checked can be located reproducibly and with adequate precision. In the case of process-engineering vessels with enameled inner walls, this means that it must be possible to determine reproducibly selected locational points for the measurement on the inner surface and in the inner volume in order to be able, for example, to monitor the occurrence and progression of wear phenomena over the course of use.

Various solutions for reproducibly locating locational points are known.

Thus, different markings have been proposed as reference points for determining locational points, such as colored markings, adhesively attached reference points, or the use of raised geometries. However, these proposals have the drawbacks that a marking applied to an enameled surface can be concealed by adhering vessel contents and thereby no longer be locatable and that colored markings have, as a rule, a lower chemical resistance than the enamel and thus, owing to corrosion, can wash off or be corroded away. In addition, the provision of raised geometries, such as tabs, bolts, weld points, etc. is not possible on enamel coatings, because the enamel coating would thereby be impaired or damaged.

A further proposed solution provides for the use of markings that are projected by photometric methods as reference points. However, for this purpose, the projection system has to be placed and installed at a suitable site in a positionally precise manner in order to be able thereby to produce projected markings on the surface. Moreover, on account of the reflection properties of enameled surfaces (mirroring), a projection of points of light is possible only with difficulty. Beyond this, on account of the often large distance between the position of the projection system and the reference point thereby projected, great deviations can ensue owing to tolerances. For an exact reproducible determination of a locational point for a measurement, for example, it is expedient, however, to place the reference point was close as possible to the locational point in order to minimize the influence of tolerances and deviations.

US 2019/0086195 A1 describes a contact-free photo-optic measuring method for distance measurements on rotating components, wherein, on the surface of the rotating component, a concave dent is provided, which can have a treated surface—for example, the surface of the dent can be coated with enamel—for increasing the reflection of a laser beam. This is intended to eliminate the problem that, in this photo-optic measuring method, the intensity of a reflected laser beam employed for the measurement decreases with time and thereby makes a precise evaluation difficult. In order to be able to establish the order of magnitude of the decrease in intensity, a comparison with a defined laser beam that is reflected at the concave dent is undertaken, wherein the deviations obtained are used for controlling the intensity.

However, a control for the absence of defects on enameled surfaces of components is not described.

Described in DE 16 73 886 A is a three-point support for a precise and secure measurement on workpieces by use of a measuring stand, wherein, at each of the three corners, a rest support, corresponding to a foot, is provided. A setup or arrangement for a reproducible, positionally precise placement on a surface, in particular in interaction with corresponding depressions or dents in the surface, is not provided. In particular, it is not possible to use this three-point support to establish the position of a point in space, because the three-point support can shift in place on the surface, as a result of which at least two spatial directions are not defined and consequently cannot be measured reproducibly.

A reproducible location of locational points is an essential perquisite for numerous other applications besides the control of the inner surface of enameled vessels, such as, for example,
for detecting the actual geometry of enameled components,
for detecting a change in the actual geometry of the component in the course of the coating with enamel, such as, for example, during the production of an enameled apparatus,
or for locating an inspection vehicle traveling autonomously or partially autonomously in the vessel.

As discussed above, however, adequately suited reference points that allow a location of locational points in a positionally precise and reproducible manner are not always available on the components and surfaces to be checked. Enameled inner surfaces of vessels are generally smooth, free of irregularities, and, in addition, reflecting, so that no reference points for an orientation are available.

The coating layer thickness of the enamel coat can also vary by up to 1 mm.

In order to be able to establish a change in the coating layer thickness, such as, for example, a decrease owing to wear, it is therefore necessary to carry out the measurements always at exactly the same site, because a measurement even at an only slightly deviating position can lead to a falsification of the results on account of an initial thickness that, under circumstances, is different. A trend in regard to a decrease in the coating layer thickness owing to corrosion, abrasion, etc., for example, can then no longer be established with certainty and an estimate of the remaining lifetime of the component is hardly possible any longer.

In accordance with the invention, this problem of locating a locational point on enameled surfaces, in particular on enameled inner walls of a vessel, in a positionally precise and reproducible manner is solved in that, on the enameled surface, at least one trough-like depression is provided as a reference point.

For simplification in the present description, the trough-like depression will also be referred to as a “dent.”

The at least one dent is advantageously produced already during the production of the enameled vessel. To this end, prior to the coating with enamel, a depression is provided in the surface of the metallic body of the vessel, of an insert part, etc., for example, at a desired position and subsequently the enamel coating layer is applied to the surface, including the surface of the dent.

The dent produced in this way can be located on the finished enameled surface at any time, even during the course of a process, in a straightforward manner.

The dent according to the invention can itself represent the point that is to be located for repeated measurements, for example, or it can serve as a reference point for establishing a locational point, which, accordingly, can be found once again with certainty.

In accordance with an embodiment, at least three dents are provided at predetermined positions in the vessel wall. This arrangement of at least three dents as a reference point allows a reproducible location of a selected locational point by means of trilateration, which in itself is known. It is thereby possible to determine securely the precise position of a point through the knowledge of the distance of this point from each of the three dents.

In accordance with a further embodiment, three dents are arranged to form triangle. In this case, the measuring point to be defined lies on the wall within the triangle spanned by the dents. The arrangement of the dents in the form of a triangle serves for fixing in place and aligning a correspondingly dimensioned three-leg device, which is set up for mounting a measuring device, such as a measuring instrument or measuring sensor, and is also referred to as a three-leg holding device. The dents that are aligned and arranged with respect to one another in a defined manner, thereby affording a three-point reference, which allows a reproducibly precise positioning of a measuring device.

The three-point reference spans a triangle mounted in a defined manner, with, for example, the point of intersection of the centroidal axis of the triangle, together with the component surface, forming a fixed and precisely reproducible and locatable point of intersection.

The three-leg holding device has feet or the like on each leg that are precisely matched to the dents, so that they are seated in the dents firmly in such a manner that they cannot be shifted laterally.

The three-leg holding device can be symmetrical or unsymmetrical in design. It is possible to provide on the feet a magnet, a suction cup, an adhesive, or the like in order to improve thereby the holding on the wall.

For a measurement, the three-leg holding device is inserted in correct in alignment into the three-point reference, so that the measuring device comes to rest exactly at the same position in each instance and the measurement always occurs at the same site.

Through the three-point reference in conjunction with the holding device, it is ensured that the measuring device can be aligned in an exactly reproducible orientation.

It is obvious that the dents are designed in such a way that they do not at all or at most only slightly impair the functionality and use properties of the component or the vessel and allow a flawless coating with enamel.

A key criterion for process-engineering vessels is the pressure-holding capability.

Consequently, on enameled inner walls of vessels, dents according to the invention have appropriately a design that does not influence at all or at most only slightly the pressure-holding capability of the vessel.

In order to not impair the pressure-holding capability, the depth of the dent should, in general, not be greater than 50% of the wall thickness of the vessel (without an enamel coating) and the diameter of the dent should be markedly smaller than the diameter of the vessel.

For a flawless coating with enamel, the shape of the dent should meet the general requirements placed on surfaces than can be coated with enamel.

In accordance with an especially suitable embodiment of the enamel coating, the dent has the shape of a spherical segment with rounded edges, with the sphere having a diameter D of at least 10 mm to 50 mm, in particular of 25 mm+/−5 mm, and the radius RK of the rounded edges being at least 3 mm to 8 mm, in particular 6 mm+/−2 mm. The depth t of the dent is at least 3 mm to 25 mm, in particular 3 mm to 7.5 mm.

For better identification, the dent can be given an enamel coating that deviates from the enamel coating of the remaining surface in that, for example, it has a different color.

The dents or the three-point arrangement of dents to create a three-point reference are or is preferably placed at positions on the enameled component that are representative for the respective local exposure, so that it is possible to obtain measurement results that are as informative as possible. In the case of enameled vessels, these positions are, in particular, the chemically and/or abrasively exposed regions, such as, for example, the regions that are in contact with the gas phase or the liquid phase and the regions at risk of wear, such as, for example, the bottom regions of the vessel, the region at the outlet ports, the stirring blades, and further insert parts.

The number, position, and alignment of the dents or the three-point references can be chosen, in principle, as needed and in accordance with the application. It is expedient for the three dents of the three-point reference to be arranged in the form of an unsymmetrical triangle with precisely defined positioning.

Through the provision of the dents according to the invention as reference points on the enameled surface, an exact and precisely reproducible positioning of a coating layer thickness measuring instrument is possible, so that the current state of the enamel coating can be monitored precisely over the course of a process.

The present invention can also be employed in a suitable way in conjunction with a locating technique based on the triangulation principle for reproducibly locating points on the inner surface and in the inner volume of enameled apparatuses. For this purpose, it is possible to install close to a dent or in a dent a system that serves as a reference point for this tracking technology. An example of a suitable tracking technology, which works on the basis of the triangulation principle, is the wireless tracking technology RedFIR® of the Fraunhofer Gesellschaft (https://www.iis.fraunhofer.de/de/ff/lv/lok/proj/refir.html). This wireless tracking technology of the Fraunhofer Gesellschaft also makes it possible to locate visually concealed objects with high precision in real time.

The present invention is explained in detail below on the basis of figures that show individual examples of possible embodiments of the present invention.

The dents and three-point references according to the invention can be introduced not only into newly fabricated apparatuses and components, but also can be introduced in the framework of a reapplication of an enamel coating and, if need be, a local repair of the enamel coating.

The present invention is explained in detail below on the basis of figures that relate to the use of the invention for process-engineering vessels and components made of steel.

However, it is obvious that the present invention can also be used for apparatuses and components made of other materials as well as for other coatings.

Shown are:

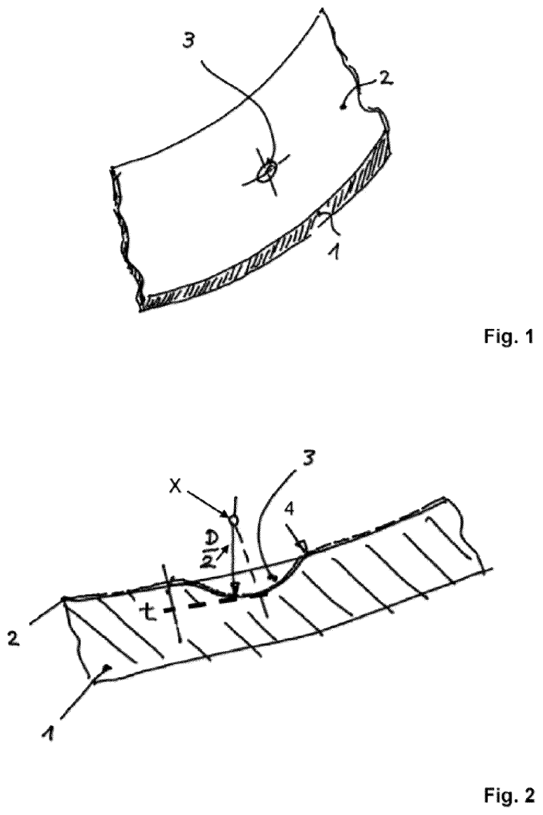

FIG. 1 a plan view of a cutout of a vessel wall with an enamel coating and a trough-like depression according to the invention,

FIG. 2 a longitudinal cut through the cutout in accordance with FIG. 1, including through the trough-like depression,

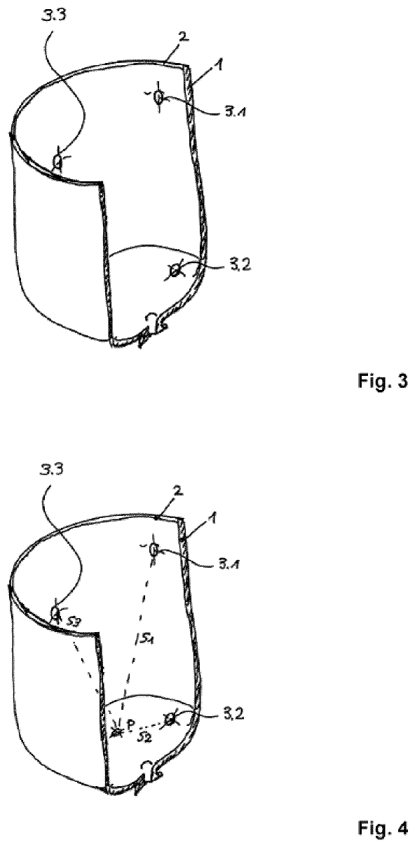

FIG. 3 a longitudinal cut through a vessel with an enameled inner wall with depressions according to the invention,

FIG. 4 the longitudinal cut in accordance with FIG. 3 with a depiction of the establishment of a locational point by means of trilateration,

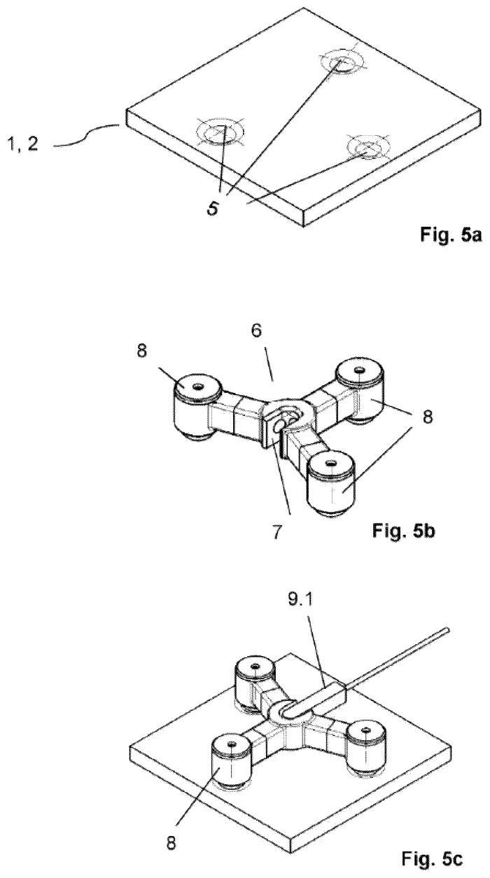

FIGS. 5a, b, c an example of an arrangement consisting of trough-like depressions as a three-point reference in combination with a three-leg holding device and alignment of a measuring sensor for a coating layer thickness measuring instrument,

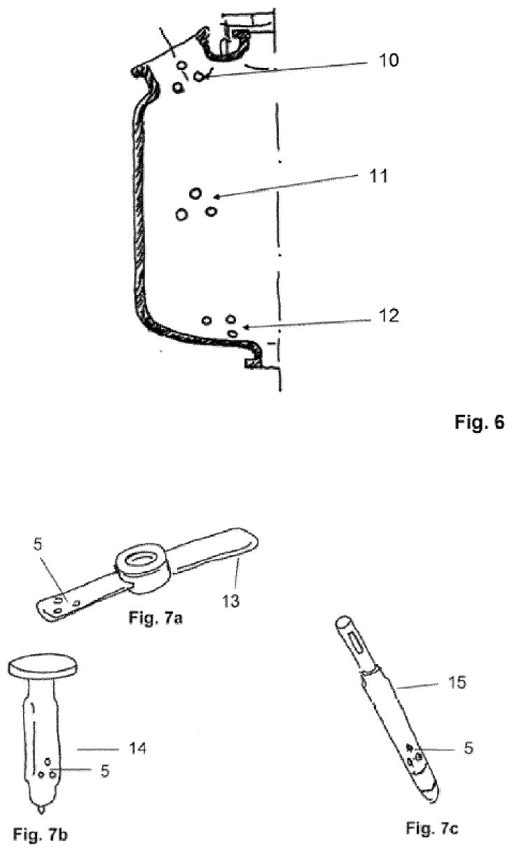

FIG. 6 the left half of a longitudinal cut through a process-engineering vessel with arrangements of the trough-like depression according to the invention as a three-point reference,

FIGS. 7a, b, c examples of insert parts for a process-engineering vessel with an arrangement of the trough-like depression as a three-point reference,

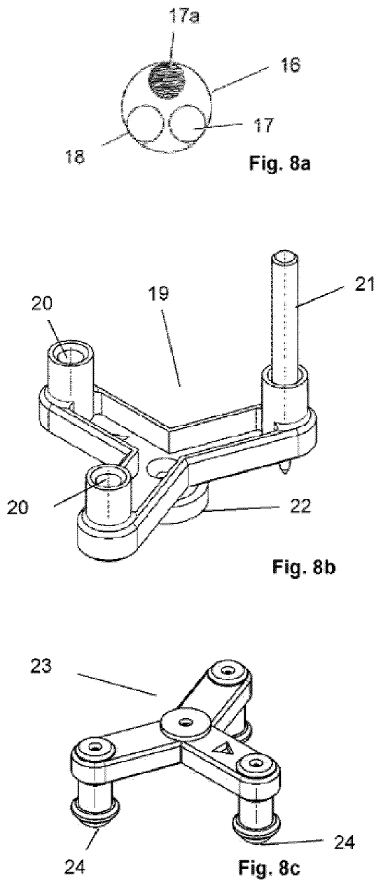

FIG. 8a a drawing template for a three-point reference,

FIG. 8b a three-leg scribing aid for marking the positions of the trough-like depressions of a three-point reference,

FIG. 8c a three-leg checking device for the production of a three-point reference consisting of trough-like depressions.

Shown in FIG. 1 is a schematic cutout of a curved wall of a process-engineering vessel with a steel wall 1, an enamel coating 2 on the inner wall, and a trough-like depression (dent) 3 on the enameled wall.

FIG. 2 shows an advantageous embodiment of the dent 3, shown in FIG. 1, as a schematic cross section through the vessel wall 1 made of steel and an enamel coating 2 on the inner surface of the steel wall 1. The dent 3 has the shape of a spherical segment with rounded edge RK 4. This shape takes into account, in particular, the prerequisites for the pressure-holding capability of the vessel with a depth t that is smaller than 50% of the thickness of the wall 1 as well as for a flawless coating with enamel owing to the rounding of the edge 4.

The specification D/2 refers to the radius of the sphere, the spherical segment of which is the dent 3, with the point x forming the center point of this sphere.

By means of the dent 3 according to the invention, it is possible to determine reproducibly locational points for measurements with the aid of the method of trilateration. To this end, at least three dents 3.1, 3.2, and 3.3 are provided in the vessel wall at different regions, as shown in FIG. 3.

In this example, two dents, 3.1 and 3.3 are situated in the upper region of the vessel and arranged opposite to each other and a third dent 3.2 is situated at the edge region of the bottom. As shown in FIG. 4, it is then possible with the aid of the dents 3.1, 3.2, and 3.3, at any time and in a positionally precise manner, to find again a selected locational point P by determining the distance of the locational point P from the dents 3.1 (S1), 3.2 (S2), and 3.3 (S3).

An example for the determination of a locational point by means of a three-point reference 5 and a three-leg holding device 6 designed correspondingly to it as well as for carrying out a coating layer thickness determination at the locational point defined in this way is shown in FIGS. 5a, b, and c.

FIG. 5a shows a region of a wall 1 with an enamel coating 2 with a three-point reference 5 consisting of three dents placed on it as well as a three-leg holding device 6 that is set up to correspond to it. In the region at which each of the legs meet with one end, the holding device 6 has a holder 7 for a measuring device 9, such as a measuring instrument, a measuring probe, or the like. The measuring point to be determined lies within the triangle spanned by the dents and corresponds expediently to the region of the holding device 6 in which a holder 7 for a measuring device 9 is situated.

At the free end of each of the legs, there is a foot 8, which, in the applied state, engages in the dent. The feet 8 have a design that exactly matches the dent and, in the present case, is an arch that exactly matches the dent. During application, the arched foot 8 comes to be seated in the dent. It is held firmly in the dent in a manner that is secure to shifting.

The feet 8 can be furnished with bonding means, which improve the holding in the dents.

Bonding means can be magnetic or suction cups, adhesives, or the like.

If the holding device 6 is inserted in the three-point reference 5, the holder 7 is situated for always accommodating the measuring device exactly above the same point on the wall (see FIG. 5b).

The measurement operation is shown in FIG. 5c. Here, a measuring sensor 9.1 of a coating layer thickness measuring instrument is inserted into a U-shaped recess as a holder 7 of the three-leg holding device 6.

The U-shaped recess of the holder 7 corresponds to the dimensions of the measuring sensor 9.1, so that the measuring sensor 9.1 can always be brought into the same position in an exactly reproducible manner.

The three-point reference 5 with the corresponding three-leg holding device 6 allows an especially simple and reproducible determination of measurement points and thus makes possible positionally precise repeat measurements, as is required for precise trend predictions.

Advantageously, in each instance, a three-point reference 5 is provided at the regions of a vessel wall that are especially representative for the measurement values that are to be determined. In the case of process-engineering vessels, as depicted schematically in FIG. 6, these positions are situated in the region of the gas phase, preferably in the region of the manhole port 10 on the 0° axis, for example, in the region of the liquid phase 11, preferably on the 0° axis of the reactor, and in the region at risk of wear at the lower bottom in the vicinity of the bottom outlet port 12, again preferably on the 0° axis of the reactor.

Besides the monitoring of the layer thickness of the enamel coating of the inner wall of a vessel, it is also appropriate, as a rule, to monitor the coating layer thickness of the enamel coating of insert parts for the vessel, because they are likewise subjected to high exposure. For the monitoring of these components, it is also possible to provide, for example, a three-point reference 5 of dents at selected regions for the reproducible positioning of a measuring device by means of the three-leg holding device 6.

Examples of this are shown in FIGS. 7a, b, and c; for example, a three-point reference 5 can be provided on the top side and/or bottom side of a stirring blade 13 in the region of the blade end (FIG. 7a), on a side at the bottom end of the paddling of a baffle 14 or multitube (FIG. 7b), or closely above the bottommost ground site of a stirring shaft 15 (FIG. 7c).

In the following, with reference to FIGS. 8a to 8c, the procedure for producing a three-point reference 5 is described based on the placement of a three-point reference 5 on an enameled inner wall of a vessel by way of example.

Further described are aids that facilitate and assist the positioning and production.

First of all, a template for the arrangement consisting of three dents (FIG. 8a) is traced at the desired site of the vessel wall that has not yet been coated with enamel, then the outline is scribed (FIG. 8b) and the trough-like depressions are ground in the desired dimensions with checking of the position (FIG. 8c), and subsequently the wall, including the dents, is coated with enamel. Finally, a quality control and documentation occurs.

As a drawing template, the perimeter 16 with three inner circles 17 has proven useful, with the three inner circles 17 being arranged along the circumference in the interior of the perimeter 16 and having a common arc segment 18 with the perimeter 16, as shown in FIG. 8. The inner circles define the three positions of the dents. Expediently, the diameter of the perimeter 16 is chosen in such a way that the inner circles 17 do not come into contact and the distance of the inner circles 17 from one another is sufficiently large for the measurement that is to be made.

For alignment and orientation, one of the inner circles 17 can be specially identified as, for example, a solid circle 17a, as depicted in FIG. 8a.

The template for the three-point reference 5 drawn in this way at the desired position on the vessel wall is given a number. In addition, the position of the three-point references 5 is recorded by specifying the value of the height and the angular position. In the case of standing vessels, the usual angular position is on the 0° axis below the manhole, for example.

For scribing the outline of the three dents on the surface of the steel wall, it is possible to use as an aid a three-leg scribing aid 19 (see FIG. 8b), the dimensions of which correspond to the dimensions of the three-leg holding device 6. At the free end of each of the three legs, the scribing aid 19 has a through hole 20 as a stencil for scribing the dent shape; for example, the through hole 20 can be provided at the free end in the form of a correspondingly dimensioned piece of hollow tubing. In one of the through holes 20, a lathe center 21 for scribing the surface of the wall is already shown in FIG. 8b.

In this embodiment, the scribing aid 19 has an adjustable foot 22, which, in FIG. 8b, is situated below the region at which the three legs meet.

The leg arrangement can be mounted rotatably on the adjustable foot 22, as a result of which the through holes 20 can be brought into the proper position as a stencil in an easy way by rotation. The scribing aid 19 makes possible in this way a precise scribing of the dents of the three-point reference 5 on a surface, such as, for example, an inner wall of a vessel.

The coating with enamel is carried out in accordance with the specification of the respective baking card, whereby the coating layer thickness of the enamel coating in the dents should be checked after each baking by way of precaution. If need be, the enamel in the dents can be ground.

Of key importance for the exact alignment of a measuring instrument is the tight, non-displaceable seating of the holding device 6 in the dents of the three-point reference 5.

The seating should therefore be checked after the baking. For the checking, it is possible to use a so-called test triangle 23, as is depicted in FIG. 8c. The dimensions thereof, inclusive of the dimensions of the legs and of the feet, correspond to the dimensions of the holding device 6. In particular, the bottom end 24 of the feet is arch-shaped in design, with the dimensions of the arches 24 corresponding to the desired dent shape.

It is then checked whether the test triangle 23 sits tightly with the arches 24 of the feet in the dents and can neither move to the side nor twist.

Subsequently, the coating layer thickness of the final enamel coating is measured by insertion of a holding device 6 with a coating layer thickness measuring instrument in the dents of the three-point reference 5.

The coating layer thickness measuring instrument or measuring probe of a coating layer thickness measuring instrument is held securely by the appropriately designed holder 7.

The three-point reference 5 according to the invention makes possible a precise alignment of the holding device 6 and thus of a measuring device for the reproducible and positionally precise recording of a defined measuring point.

The three-point reference 5 according to the invention, expediently in conjunction with the holding device 6, makes it possible in an easy way to carry out precise, reproducible, and positionally exact measurements.

### LIST OF REFERENCE CHARACTERS

1 steel wall
2 enamel coating
3, 3.1, 3.2, 3.3 trough-like depression (dent)
4 rounded edge (RK)
D/2 radius of the sphere of the spherical segment
x center point of the sphere
5 three-point reference
6 three-leg holding device
7 holder (for measuring instrument, etc.)
8 foot
9 measuring device
9.1 measuring sensor
10 manhole port
11 region of the liquid phase
12 bottom outlet port
13 stirring blade
14 baffle
15 stirring shaft
16 perimeter
17 inner circle
17a inner circle with marking
18 common arc
19 three-leg scribing aid
20 through hole
21 lathe center
22 adjustable foot
23 test triangle
24 arch

1. Method for reproducibly locating one point or a plurality of points on an enameled surface of an apparatus or component, wherein at least one reference point is provided on the enameled surface and the at least one reference point is a trough-like depression in the enameled surface,
wherein the point to be located is the at least one trough-like depression itself or can be determined reproducibly with the aid of the at least one trough-like depression.

2. The method according to claim 1, wherein at least three trough-like depressions are provided as reference points in the enameled surface.

3. The method according to claim 2, wherein the point to be located is determined by trilateration by means of the at least three reference points.

4. The method according to claim 1, wherein three trough-like depressions are arranged to form a triangle as a three-point reference.

5. The method according to claim 4, wherein the three trough-like depressions are arranged in the form of an unsymmetrical triangle.

6. The method according to claim 1, wherein the enamel coating of the dents and/or the enamel coating in the immediate vicinity of the dents have or has another colored design than the enamel coating of the apparatus or of the component.

7. The method according to claim 1, wherein the enameled surface is the inner wall of a vessel.

8. The method according to claim 1, wherein the trough-like depression has the shape of a spherical segment, with the sphere having a diameter D of at least 10 mm to 50 mm and the spherical segment having a depth t of at least 3 mm to 25 mm.

9. The method according to claim 8, wherein the trough-like depression has rounded edges with an edge radius RK of at least 3 mm to 8 mm.

10. The method according to claim 4, wherein, for the determination of a point to be located, a three-leg holding device is inserted into the trough-like depressions, which are arranged to form a three-point reference.

11. The method according to claim 10, wherein the three-leg holding device for holding a measuring device is set up for making a measurement at the point to be located.

12. Process-engineering vessels that have an enameled inner wall, wherein, on the enameled inner wall, at least one trough-like depression according to claim 1 is provided.

13. The process-engineering vessels according to claim 12, wherein, on the enameled inner wall of the vessel, at least three trough-like depressions are provided as reference points for the determination of a point to be located by means of trilateration or at least one three-point reference is provided.

14. Insert part for a process-engineering vessel, wherein the insert part has an at least partial enamel coating and, in the enamel coating, at least one trough-like depression is provided for locating locational points.

15. Holding device for a measuring device for fixation and alignment in a three-point reference, set up for carrying out a method according to claim 4,
wherein the holding device has three legs,
wherein each of the legs have a foot at its end, with the feet being set up to match exactly the trough-like depressions of the three-point reference, and
wherein the holding device has a holder for a measuring device.

16. Measuring device according to claim 15, wherein the feet are furnished with magnets.

17. Use of a holding device according to claim 15 for a method according to one claim 4.
